(19) United States
(12) Patent Application Publication
(10) Pub. No.: US 2006/0275335 A1
(43) Pub. Date: Dec. 7, 2006

(54) Pest control

(75) Inventors: Peter F. McKernan, Lancaster, PA (US); James H. Heath, York, PA (US); Priscilla S. MacLean, Boiling Springs, PA (US); Willard N. Starner, York, PA (US); James D. Nelson, Wenatchee, WA (US)

Correspondence Address: SUGHRUE MION, PLLC, 2100 PENNSYLVANIA AVENUE, N.W., SUITE 800, WASHINGTON, DC, 20037, US

(73) Assignee: Aberdeen Road Company

(21) Appl. No.: 11/430,007

(22) Filed: May 9, 2006

Related U.S. Application Data
(60) Provisional application No. 60/678,790, filed on May 9, 2005.

(51) Int. Cl. A01N 31/00

(52) U.S. Cl. 424/405; 514/739

(57) ABSTRACT

A method of pest control. The method includes mass-distributing throughout a predetermined application area monolayer or multilayer structures containing a bio-active material in at least one layer thereof.

This application claims benefit of Provisional Application No. 60/678,790 filed May 9, 2005, the entire disclosure of which is incorporated herein by reference.

### FIELD OF THE INVENTION

The invention relates to methods for controlling pests, attractant and repellant compositions, and their methods of application.

### BACKGROUND OF THE INVENTION

Many pests harmful or otherwise undesirable to humans or useful animals and plants present a serious health hazard and an economic drain on resources. Insects are typical in this respect and are a constant threat to the food supply. The damage done and disease spread by locusts, gypsy moths, fruit flies, house flies, rats, and mosquitoes, just to name a few, is well-known, and the efforts expended by humans to control such pests have been enormous and continue to be a great economic burden.

Over the years, a wide variety of physical and chemical means have been developed in an attempt to eradicate pests or at least control their numbers within acceptable limits. The application of synthetic and natural chemicals has been particularly effective in controlling certain target species.

For a wide range of reasons, however, the use of chemical pest control agents has met with only limited success in certain applications. For example, many chemicals need to be applied at dosage schedules which are difficult to achieve in the field. Others have undesirable side effects. Environmental considerations are also important.

Much attention has therefore been directed to improvement in methods for delivering pest control agents so as to maximize economic benefits and minimize negative environmental effects. In commercial applications against agricultural pests, for example, much study has been directed to the timing of the spraying of insecticides on field crops, orchards, vineyards and the like. Proper timing in the application of the insecticide can be essential to combat a particular pest species effectively at a reasonable cost.

Much study has also been directed to prolonging and controlling the release of pesticides and other active chemicals through microencapsulation of the chemicals.

Microencapsulation involves interfacial polymerization between directly co-acting intermediates in immiscible liquids. This method demands very precise control of such process conditions as times, temperatures, quantities and intensity of agitation. Microencapsulation methods therefore are difficult to practice and have the drawback of high cost of manufacture as a result of the complexity of equipment and processing steps. They require particularly careful process control to prevent agglomeration of microcapsule and production of defective microcapsule walls. Furthermore, microencapsulation limits the selection of polymer and of active chemicals, as not all film-forming polymers lend themselves to suitable encapsulation of all active chemicals which may be desirable in the present context. Still further, the release rate of active chemicals using microencapsulation technology has proven uncontrollable in practice.

Despite a great increase in knowledge concerning techniques of pest control, there is unsatisfactory control for many pests, and there exists a need for the improved control of other species especially from the standpoint of economics.

### SUMMARY OF THE INVENTION

In an aspect, the invention features a method of pest control. The method includes mass-distributing throughout a predetermined application area monolayer or multilayer structures containing a bio-active material in at least one layer thereof.

Embodiments may include one or more of the following.

The monolayer or multilayer structures may be mass-distributed by spraying or aerial application, including, but not limited to, modified sprayer, modified leaf blower, modified helicopter applicator bucket, mechanical spreading, and specialized aerial application equipment. The monolayer or multilayer structures may be mass-distributed by spraying with the aid of a fluid carrier such as air, water, fertilizer solutions, or herbicide solutions. The predetermined application area may be an orchard.

The monolayer or multilayer structures may include a three-layer film structure containing, in order, a first outer layer, a middle reservoir layer, and a second outer layer. The middle reservoir layer may contain the bio-active material. The bio-active material may be a pest attractant. In an embodiment, the pest attractant may be a pheromone, and after mass distribution, the monolayer or multilayer structures may provide at least two phases of pest control in the predetermined application area: a first phase including generation of a masking cloud of pheromone; and a second phase including generation of false trails of pheromone. The pheromone may be (E,E)-8,10-dodecadien-1-ol. The predetermined application area may be an apple orchard.

Some or all of the monolayer or multilayer structures may also include, in addition to the pheromone, a second bio-active material in at least one layer thereof. The second bio-active material may be, for example, a pesticide, a chemosterilant, an anti-metabolite, a juvenile hormone, or another pheromone.

After mass-distribution, the monolayer or multilayer structures may be present in the predetermined application area in a total amount of from 1 to 10,000 g/acre, based on the weight of the monolayer or multilayer structures, or the bio-active material may be present in the predetermined application area in a total amount of from 0.1 to 5,000 g/acre, based on the weight of the bioactive material.

Embodiments may have one or more of the following advantages.

Methods of the invention achieve efficacious control of pest populations by optimizing the effect of one or more pest control methods through the efficient application of monolayer or multilayer structures containing a bio-active material in at least one layer thereof. The monolayer or multilayer structures of the invention have long-lasting effectiveness and may be efficiently applied by methods of the invention to a wide variety of sites. Methods of the invention may be economically advantageous in that they achieve excellent pest control through the use of a relatively small amount of bio-active material per acre of application area. In embodiments where the bio-active material is a pheromone, methods of the invention advantageously generate two mechanisms of pest control action: a masking phase and a “false trail-following” phase.

Further aspects, features, and advantages will become apparent from the following.

### BRIEF DESCRIPTION OF THE DRAWINGS

FIGS. 1-5 are cross-sectional views of multilayer structures made in accordance with the invention.

FIG. 6 is a schematic view of a process for making the structures of the invention.

### DETAILED DESCRIPTION OF THE PREFERRED EMBODIMENTS

The material(s) for forming the layer or layers of the monolayer or multilayer structures of the invention is not particularly limited. According to preferred embodiments of the invention, the layer or layers of the monolayer or multilayer structures may comprise a film-forming thermoplastic polymer.

Furthermore, the method of forming the monolayer or multilayer structures of the invention is not particularly limited. According to preferred embodiments of the invention, the monolayer or multilayer structures are film structures formed by a method comprising blown or cast film extrusion. According to particularly preferred embodiments of the invention, the structures are multilayer structures formed by a method comprising lamination or coextrusion.

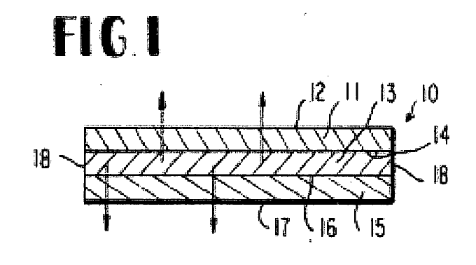

Referring to FIG. 1, a multilayer structure 10 comprises a laminated article containing the bio-active material(s) to be released. The structure 10 has a polymeric first outer layer 11 through which the bio-active material is capable of migrating to establish an effective level of pest control activity throughout first outer layer 11 and on the outer or exposed surface 12 of first outer layer 11 and to provide an effective level of pest control in the environment of structure 10. Preferably, first outer layer 11 is a solid and non-porous polymeric layer. Preferably, the bio-active material(s) is sealed within structure 10 in reservoir layer 13 which is substantially isolated from the atmosphere. Reservoir layer 13 of structure 10 may be formed from a polymeric composition and may be bonded or adherently applied to first outer layer 11 at interface 14.

The bio-active material(s) in reservoir layer 13 and the composition of first outer layer 11 are selected for their ability to allow the bio-active material(s) to migrate across interface 14 and throughout first outer layer 11 to provide a multiple effect in the environment of structure 10. One effect is the achievement of an effective level of bio-active material(s) on surface 12 of first outer layer 11 for a desired period of time. A second effect is the migration of bio-active material(s) to surface 12 of first outer layer 11 and further migration of bio-active material(s) from surface 12 into the environment surrounding structure 10. In certain embodiments, the second effect causes pests to move towards and contact bio-active material(s) on surface 12 of structure 10.

Second outer layer 15 is also coextensive with reservoir layer 13 and may function in a similar manner as first outer layer 11. If second outer layer 15 is of the same composition as first outer layer 11, the migration of bio-active material(s) across interface 16, throughout second outer layer 15 and onto surface 17 will take place in the same fashion and with the same effects as result from, migration through first outer layer 11. Second outer layer 15 may, however, be different from first outer layer 11 and may act to control migration either by blocking migration completely or by controlling the dispensing rate at a different level.

In FIG. 1 it will be seen that substantially all of the surface area of reservoir layer 13 is protected from the atmosphere by outer layers 11 and 15. Only the relatively small edge areas of reservoir layer 13 are exposed and this constitutes a relatively minor portion of the total surface area of layer 13.

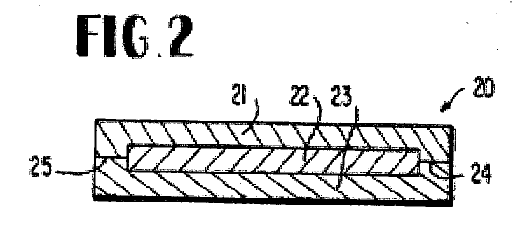

As shown in FIG. 2, even the edge areas of the reservoir layer or layers can be isolated from the atmosphere by sealing the edges of the outer layers. Referring to FIG. 2, a structure 20 is shown which is generally similar to structure 10 described with reference to FIG. 1, but outer layers 21 and 23 are sealed at their edges 24 and 25 to completely encapsulate reservoir layer 22.

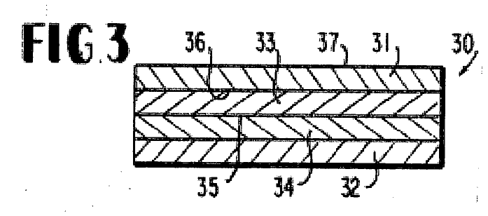

In another embodiment of the invention as shown in FIG. 3, first and second bio-active materials may be segregated in first and second layers, respectively, of a film structure. This provides another approach to the control of the rates of migration of the bio-active materials to the surface of the film structure and to the surrounding environment. Referring to FIG. 3, it will be seen that structure 30 comprises two outer layers 31 and 32 and two interior (reservoir) layers 33 and 34. First outer layer 31 may comparable in composition and function to first outer layer 11 of structure 10 shown in FIG. 1. For example, it may be formed of a solid, non-porous polymeric material selected to allow the migration of the bio-active material(s) from out of interior layers 31 and 32.

By placing different bio-active materials in different layers, some additional control may be exercised over the out-migration of the respective bio-active materials from the interior layers. The path of one bio-active material may be lengthened and caused to pass through interface 35 between layers 33 and 34, then through layer 35, across interface 36 between layers 33 and 31, and through layer 31 in order to reach surface 37 of layer 31. This longer path can be used to retard the loss of bio-active material from the structure.

Outer layer 32 may be selected to block completely the migration of any of the bio-active materials, to block selectively the migration of some of the bio-active materials, or to exercise some other control or moderation on the migration of the bio-active materials. Similar to the structure shown in FIG. 2, outer layers 31 and 32 may be sealed to encapsulate completely inner layers 33 and 34.

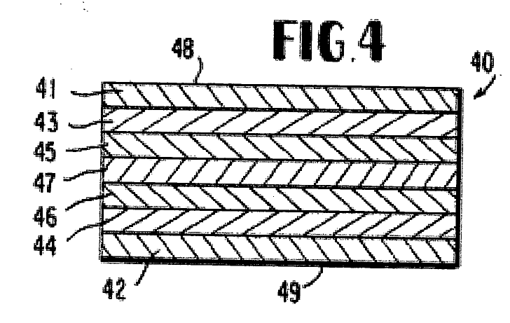

The basic structure may be doubled or repeated to give a product both faces of which will exhibit the same properties. By way of example and referring to FIG. 4, basic structure 30 from FIG. 3 can be repeated on each side of a center or core layer to produce a useful embodiment of the invention wherein the structure has the same activity on each surface. In the case of structure 40 of FIG. 4, pairs of identical outer layers 41 and 42 and bio-active material-containing layers 43, 44, 45, and 46 are combined with a core layer 47 to provide a product of the type described above in which the surfaces 48 and 49 of the structure should exhibit virtually identical activity.

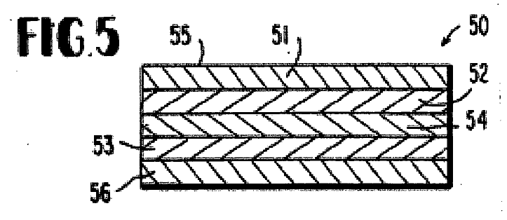

Another very effective structure for exercising especially effective control over the rates of delivery of the bio-active materials is illustrated in FIG. 5. According to this embodiment, structure 50 has an outer layer 51 which is a solid, non-porous polymeric material which allows migration of the bio-active materials present in interior layers 52 and 53, respectively. Layer 54 is specially selected so that it allows migration of the specific bio-active material in layer 53, but only at a suitably slow rate so that the bio-active material from layer 53 is available for out-migration through layers 52 and 51 for an extended period of time.

Likewise, migration of the bio-active material from layer 52 through layer 51 and onto the outer surface 55 of layer 51 can be optimized by choosing for the material of layer 51 a polymeric composition in which the bio-active material from layer 52 has a lower solubility than it has in the polymer of layer 52. As with the other structures described above, outer layer 56 may serve as a partial or total barrier to migration of the bio-active materials.

By utilizing the structure shown in FIG. 5, relatively large concentrations of bio-active materials can be stored in layers 52 and 53 respectively, and their delivery to the environment can be extended over long periods of time and mutually timed so that bio-active materials from both layer 52 and 53 are available at effective levels for approximately the same period of time. Thus, by taking advantage of the “valve” function of selected polymeric materials in layers 51 and 54, the delivery of the bio-active materials can be selectively controlled to optimize the economic utility of expensive chemical agents against target species and to minimize adverse environmental effects. Likewise, the protection of unstable bio-active materials is effectively achieved, and may be further enhanced by sealing of the edges of outer layers 51 and 56 in a similar manner as described above with other embodiments of the invention.

Doubling or repetition of the structure shown in FIG. 5 may also be accomplished in comparable fashion as was employed in the embodiments illustrated in FIGS. 3 and 4.

The monolayer or multilayer structures of the invention are capable of being deployed in a wide variety of ways and in various structural forms. The monolayer or multilayer structures can be manufactured to any desired size or shape specification. The monolayer or multilayer structures made in accordance with the invention can be punched, chopped, shredded or otherwise comminuted, and the resulting product can be deployed by aerial application or by spraying with the aid of any suitable fluid carrier, e.g., air, water, fertilizer solutions, herbicide solutions, and the like.

For example, the monolayer or multilayer structures of the invention lend themselves to application by spray by airplane, back-pack pressurized spray container and hand-held aerosol spray dispenser. As applied, the monolayer or multilayer structures are entrained in fluid carrier. For example, the monolayer or multilayer structures of the invention may be mixed with a fluid which serves as a carrier and may also have an additional function as a fertilizer, herbicide, short term pesticide, pest attractant or the like. In the case of application of the monolayer or multilayer structures of the invention to, for example, a collection of trees, such as an orchard, as the monolayer or multilayer structures exit the nozzle of the spraying apparatus, they are simultaneous treated with a suitable adhesive solution spray to render them “sticky” and assure their attachment to and retention by the foliage of the orchard.

Monolayer or multilayer structures of the invention which have been treated with an adhesive in order to adhere to a tree canopy do not permanently adhere to the tree canopy. They will eventually fall to the floor of the orchard due to weather conditions, etc. However, even those monolayer or multilayer structures that miss a tree and/or fall to the floor of the orchard are efficacious.

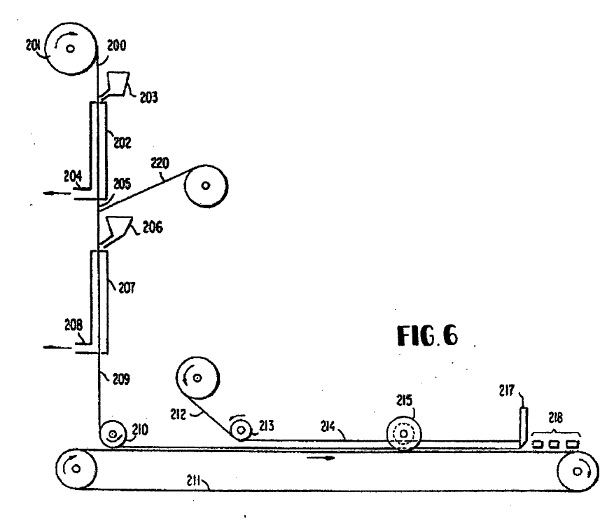

A suitable method for forming the monolayer or multilayer structures of the present invention will be illustrated by referring to FIG. 6 of the drawings. FIG. 6 illustrates a schematic arrangement for the continuous manufacture of monolayer or multilayer structures containing multiple bio-active materials, such as a combination of a chemosterilant or insecticide, and a sex attractant. A substrate material 200 (which may be a solid, non-porous, polymeric film through which bio-active materials are designed to migrate) is continuously advanced from a roll 201 or other supply through a coating device 202 wherein a first bio-active material is coated on substrate 200. The first bio-active material is supplied to coater 202 from applicator 203. The first bio-active material may be applied in liquid form and dried in the coater device 202. Excess of first bio-active material not coated adherently to substrate 200 is recovered by removal from device 202 at location 204, thereby producing a first bioactive material-coated substrate 205. This coated substrate is then passed through another applicator device 207 where a second bio-active material is coated thereon from applicator 206. Any excess second bio-active material can be recovered as before by removing the excess from device 207 at location 208, to produce a substrate 209 having two bio-active materials coated thereon (on separate areas of the substrate or the same areas).

Subsequently, the coated substrate 209 is passed around guide roller 210 and onto a traveling conveyor belt 211 advancing in the direction shown. For the production of a multilayer structure, an upper layer 212 may then be laminated onto the coated substrate. The material of layer 212 may be, for example, a polymeric film through which the bio-active materials are designed to migrate, depending upon which side or sides of the resulting multilayer film structure are designed to have surfaces with bio-active material activity. The upper layer or film 212 is passed around guide roller 213 and laminated onto coated substrate or film 209 forming laminate 214. The formed laminate is then passed through a sealer device 215 and cutter 217 which heat seals and slits the laminate 214 into strips, which strips may then subsequently be passed through lateral or other slitters or comminuters to form individual multilayer film structures 218.

Many variations are possible and monolayer or multilayer structures of varied sizes and shapes can be formed containing any desired amount of bio-active materials and using any desired material or materials for the substrate and other layer(s). In addition, by controlling and varying the width of the strips formed, the rate of migration and activity can be controlled. If desired, a co-eluant or co-solvent for some or all of the bio-active materials can be applied during the production operation to thereby increase or decrease the rate of migration of the bio-active materials through outer layers of the structures.

The monolayer or multilayer structures of the invention provide several beneficial effects that contribute the efficacy of the invention, including (1) protection of the incorporated bio-active material(s) from premature environmental decomposition or degradation and (2) regulation of the release of the bio-active material(s) over a prolonged period of time to maximize the desired effect.

Among the bio-active materials which can be controllably dispensed by the monolayer or multilayer structures of the invention are insecticides, rodenticides, acaricides, nematocides, molluscides, lamprey toxicants, anthelmintic substances, insect, bird and animal repellents, flumigants, algicides, insect growth regulators, insect antiaggregants, antimetabolites, chemosterilants, juvenile hormones, analogs and mimics; and such pest foods and food mimics, any of the foregoing of which are capable of migration, ingestion or contact action.

The present invention thus allows the use of, among other bio-active materials, bio-active materials which heretofore have not enjoyed widespread use in view of the fact that they are relatively difficult or expensive to produce or due to the fact that they rapidly decompose or dissipate in the atmosphere. In addition, the present inventors have determined that bio-active materials which undergo relatively rapid decomposition when exposed to atmospheric conditions remain active for prolonged periods of time when sealed within the monolayer or multilayer structures of the invention and maintain an effective level of activity on outer surfaces of the monolayer or multilayer structures for significant periods of time.

According to the present invention, several different types of bio-active materials may be incorporated in the monolayer or multilayer structures in order to achieve different effects. For example, the monolayer or multilayer structures may contain therein one or more chemosterilants alone or in combination with other bio-active materials such as one or more attractants, pesticides, insecticides, etc. all of which are capable of migrating through the outer layers of the structures. The monolayer or multilayer structures are designed so that the outside surfaces of the structures will have an effective level of activity which has the desired degree of intensity and which is constantly replenished by continuing migration of the bio-active materials contained within the structures.

The bio-active materials may be largely or completely contained between outer layers of the structures. One or both outer layers may be a polymeric material through which the bio-active materials are capable of migrating. Having migrated through the outer layer(s) and to the outer surface(s) of said layer(s), the bio-active materials may evaporate or diffuse into the surrounding atmosphere wholly or in part, or they may essentially remain deposited on the surface of the outer layer to be effective by contact with the target pest.

In embodiments where the monolayer or multilayer structures are shredded or otherwise formed into a confetti-like configuration, the outer surfaces of the structures may be treated with a slip-promoting substance so that, after cutting and packing, the individual structures separate easily, as may be desirable, for example, in the case of spraying or aerial application.

A further embodiment comprises forming the monolayer or multilayer structures of the invention utilizing biodegradable plastic materials, such as cellulosic materials etc., which are designed to biodegrade at approximately the time that the bio-active materials contained in the monolayer or multilayer structures are unable to provide effective levels of activity in the environment of the monolayer or multilayer structures.

The bio-active materials that are designed for use in certain embodiments of the invention comprise generally any pest controlling and pest attractant substance which is capable of migrating from one side of and through polymeric layers, including solid, non-porous, polymeric layers, to establish effective levels of pest control and pest attractant activity on the outer surface of the monolayer or multilayer structures. The bio-active materials should also be capable of continuing such migration to replenish the activity level on the outer surface of the monolayer or multilayer structures.

Typical examples of bio-active materials suitable for use in the invention include: insect repellants; insect anti-aggregants; chemosterilants, including alkylating agents, antimetabolites, radiomimetic compounds, and mitotic poisons; juvenile hormones, including ethyl-3,7,11-trimethyldodeca-2,4,-dienoate, isopropyl-11-methoxy-3,7,11-trimethyldodeca-2,4-dienoate, and various terpene derivatives; pheromones or attractants, including insect feeding attractants and insect ovi-positional attractants; pesticides, including malathion (i.e., phosphorodithioic acid, S-[1,2,-bis(ethoxycarbonyl)ethyl]-1,0-dimethyl-ester), pyrethrins, allethrin, DDVP (i.e., dimethyl-2,2-dichlorovinyl phosphate), parathion, and methyl-parathion; and antimicrobial pesticides.

The above examples of operable bio-active materials are to be deemed only exemplary, with any of the known pesticidal or insecticidal active materials being operable in the present invention as long as they are capable of migration, ingestion or contact action.

Suitable materials through which the bio-active materials can migrate are polymers, such as polyolefins, especially lower polyolefins, polyvinylchloride, polyvinylfluoride, polychlorotrifluoroethylene, polyester urethane, polycarbonate, polyamide, polyethylene terephthalate, polyvinylidenchloride, polybenzimidazole, ethylene-acrylic acid copolymer ionomers, cellulose acetate, regenerated cellulose film (cellophane), polystyrene, etc.

The inventors have found that the rates of migration vary for different types of bio-active materials through different types of materials and, depending upon the level of activity desired on the outermost surface of the monolayer or multilayer structures, different materials may be used to achieve the desired results in controlling the target pest. In addition to the need for the proper selection of materials, several other techniques are available for controlling the rate of migration through the outer layers of the monolayer or multilayer structures of the invention.

For example, additional control of dispensing or delivery of bio-active materials may be accomplished by selecting two layers which differ in composition and/or thickness, so as to result in different rates of migration through them by the bio-active materials contained in multilayer film structure embodiments. For instance, by proper control of the multilayer construction, a first bio-active material may be caused to migrate through an outer layer of a certain composition, and a second bio-active material through an outer layer of different composition. As another embodiment of our invention, the bio-active materials may be caused to migrate through outer layers of the same composition, but different thicknesses. Two such layers of identical composition, but different thicknesses, will cause the layer having the greater thickness to attain the desired level of activity on its outer surface later than the thinner layer.

A further manner of controlling the rate of migration of the bio-active materials through the outer layers of the monolayer or multilayer structures of the invention is to reduce the effective concentration of the bio-active material within the monolayer or multilayer structure. As an example, the concentration of the bio-active material can be reduced by introducing into the monolayer or multilayer structure, along with the bio-active material, a second material in which the bio-active material is soluble. By selecting a second material which does not migrate through the material of the outer layers of the structure and which is a solvent for the bio-active material, the concentration of the bio-active material is effectively decreased resulting in a decrease in the rate of migration through the material of the outer layers.

Of course, the use of a co-solvent is not required to lower the concentration of the bio-active material in a layer in order to slow its release rate. The quantity of the bio-active material in the layer may simply be reduced, which will slow its release rate. Raising the concentration of the bio-active material in a layer will accelerate its release rate, at least initially.

Any particular mass distribution of the monolayer or multilayer structures of the invention to a predetermined application area may include a first group of monolayer or multilayer structures comprising one or more bio-active materials and a second group of monolayer or multilayer structures comprising one or more bio-active materials which may be the same or different bio-active materials as comprised within the first group of monolayer or multilayer structures. Third and higher groups of monolayer or multilayer structures may also be included in the particular mass distribution.

A preferred application of the invention includes the mass-distribution of monolayer or multilayer structures according to the invention in an apple orchard to effectively control the population of codling moth (Cydia pomonella), which is the primary pest of apple orchards.

The pheromone codlemone, (E,E)-8,10-dodecadien-1-ol, is naturally produced by the female codling moth and functions as a chemical scent attracting the male codling moth to the female for mating purposes.

According to this preferred method of the invention, monolayer or multilayer structures containing synthetically manufactured codlemone, which is chemically identical to naturally produced codlemone, are produced. Particularly preferred are multilayer structures consisting of three layers: a pair of outer layers and a middle reservoir layer. The outer layers comprise polyvinyl chloride resin. The middle reservoir layer comprises polyvinyl chloride resin, codlemone, and a plasticizer. The polyvinyl chloride resin, codlemone, and plasticizer of the middle reservoir layer have been mixed together and cured to create a polymer matrix that protects the codlemone from environmental degradation and rapid evaporation. The contained codlemone will slowly migrate out of the matrix to the outside edges of the multilayer structures and be continuously released into the environment for up to 12 weeks in ideal conditions, depending on temperature, until the codlemone content of the structures is exhausted.

At least some of the monolayer or multilayer structures may also include, in addition to the pheromone, at least a second bio-active material. The second bio-active material may be, for example, a pesticide, a chemosterilant, an anti-metabolite, a juvenile hormone, or another pheromone. Alternatively, while a first group of the monolayer or multilayer structures may include a pheromone and, optionally, one or more additional bio-active materials, a second group of monolayer or multilayer structures mass distributed with the first group may include a completely different set of bio-active materials. Third and higher groups of monolayer or multilayer structures may also be included in any particular mass distribution.

Strategies for deploying pheromone-based pest control products include hand-applied methods or spray-applied methods which do not use the monolayer or multilayer structures of the invention. Hand-applied methods, which include hanging basket, twist-tie and pouch applications, have the advantage of providing season-long control with one application, but require costly hand-labor to apply to a crop or stand of trees. Spray-applied methods which do not use the monolayer or multilayer structures of the invention are easier and cheaper to apply than hand-applied methods, but provide only a few weeks effect, such that multiple applications are required throughout the season to maintain control. In both cases, relatively large amounts of pheromone are required to maintain an effective pheromone “cloud” in the application site in order to “mask” the natural pheromone trails emitted by female insects and to confuse and disrupt the male insects as they search for female partners.

According to the present preferred embodiment of the invention, the monolayer or multilayer structures are not hand-applied. Instead, the monolayer or multilayer structures containing codlemone are processed into small squares, rectangles or other geometric shapes suitable for mass distribution to an apple orchard by, for example, ground or aerial application, including spraying or blowing, e.g., by modified leaf blower, with the simultaneous addition of a suitable adhesive solution spray to promote their attachment to and retention by the foliage or canopy of the apple orchard. Preferably, the monolayer or multilayer structures are processed into ⅛ inch squares.

After mass distribution, the monolayer or multilayer structures provide at least two phases of pest control in the predetermined application area: a first phase comprising generation of a masking cloud of pheromone; and a second phase comprising generation of false trails of pheromone.

In particular, for an initial period following mass distribution, the applied monolayer or multilayer structures emit sufficient codlemone to generate a masking “cloud” of codlemone similar to the effect caused by hand-applied methods or spray-applied methods which do not use the monolayer or multilayer structures of the invention. That is, the released codlemone by the preferred method of the invention at first permeates the treated area with a burst of pheromone, masking the chemical scent trails produced by the female codling moths.

However, the mass distribution of the monolayer or multilayer structures provides discrete multiple point-sources for the release of pheromone (codlemone) that permit a second mechanism of mating disruption to occur, namely “false trail-following.” Unlike hand-applied methods or spray-applied methods which do not use the monolayer or multilayer structures of the invention, after the bulk of the pheromone in the monolayer or multilayer structures is expended and the masking effect dissipates, for an additional extended period of time, enough pheromone is still emitted from each discrete multiple point-source (monolayer or multilayer structure) to mimic a female insect's release of naturally produced pheromone.

The male codling moths are unable to determine whether a trail is from the female or from the monolayer or multilayer structure. Since a given acre may contain, for example, 10,000 to 20,000 monolayer or multilayer structures, these “decoy females” provide competition to any female codling moths that may be present in the application site and effectively prevent mating by causing the males to spend their time and energy following “false trails.” The quantity of codlemone required to generate effective mating disruption by this false trail-following mechanism can be significantly less than the amount required to generate and maintain the pheromone cloud required for the masking mechanism of mating disruption.

Thus, according to the present preferred embodiment of the invention, the codlemone-containing multilayer film structures slowly release sufficient codlemone over the course of, for example, 60-75 days to effectively disrupt the mating of the codling moth and thereby prevent population explosions of damaging codling moth larvae in the application site. Masking the female chemical scent trails and false trail-following results in the reduction of mating and, ultimately, the decrease in the next generation population numbers. Therefore, codling moth can be controlled for the entire season with only two applications each lasting, for example, 60-75 days.

An advantage of the present preferred embodiment can be seen by a comparison with spray-distributed, microencapsulated pheromone, which is a typical spray-applied method which does not use the monolayer or multilayer structures of the invention. Like the present preferred embodiment, spray-distributed, microencapsulated pheromone permeates the treated area with a burst of pheromone, masking the chemical scent trails produced by the female codling moths.

However, spray-distributed, microencapsulated pheromone does not provide discrete multiple point-sources that mimic a female insect's release of naturally produced pheromone. Because the size of microencapsulated pheromone is comparatively small, typically one-hundredth to one-thousandth the size of the point-sources of the present preferred embodiment, spray-distribution of microencapsulated pheromone yields a coating on an orchard or other predetermined application area which is continuous. Without the discrete multiple point-sources generated by the method of the present preferred embodiment, the female insect's release of naturally produced pheromone is not mimicked, and the false trail-following mechanism does not occur.

While the preferred pheromone-containing embodiment has been described in relation to codling moths, it will be understood that other preferred embodiments of the invention can take advantage of the phenomena of false trail-following with other pheromones for the population control of other insects.

As a general example of one possible method of mass-distributing a monolayer or multilayer structure containing pheromone, an ATV cycle or similar vehicle having blower equipment containing a product feed hopper mounted thereon has a sufficient weight of “flakes” of the monolayer or multilayer structure added to the feed hopper to treat a target orchard at the desired application rate (e.g., 10 pounds of flakes to treat 10 acres at a rate of 1 pound of flakes per acre). The flakes may have been prepared, for example, by comminuting monolayer or multilayer structures into ⅛ inch squares.

The calibration of flake feed is checked by adjusting the hopper feed motor speed to allow delivery of the desired weight of flakes per acre in the time required to drive through one acre of orchard, treating every second tree row. For example, 0.25 pounds of flakes per minute may be sufficient to treat one acre of orchard with a 15 foot tree row spacing at a rate of 1 pound of product per acre by driving at 4.2 miles per hour through every second row in the orchard block, or at the rate of one acre every 4 minutes). Preferably, the blower nozzle can be adjusted to assure the majority of flakes are landing on the upper third of the tree canopy.

Preferably, the blower equipment is adapted to allow for the simultaneous delivery of an adhesive solution spray with the flakes in order to render the flakes “sticky” as they are blown onto the orchard canopy. The calibration of the adhesive solution feed may be checked and the spray pump motor speed adjusted to deliver the desired amount of adhesive solution spray mixture per pound of flakes in the time previously calculated for driving through the orchard.

A number of terms used frequently in this application are defined and intended to include any or all of the following.

The term “pest” as used herein is intended to include animals and all other lower forms of life undesirable in the context of this invention from man's economic or environmental point of view, including mammals, birds, vertebrates, insects, invertebrates, worms, fungi, molds, protozoa, viruses bacteria, and other organisms capable of reproducing or multiplying.

The term “control” as used herein is intended to include all activities and properties tending to kill, debilitate, repel, incapacitate, sterilize, impair the sex drive, cause mutation, inhibit propagation and interfere with or alter the normal development, reproduction, metamorphosis, existence, behavior and habits of pests, so as to render them or their progeny harmless or incapable of undesirable activities.

The term “pesticide” is intended to include all substances tending to kill, debilitate, repel, incapacitate, or control pests.

The term “bio-active material” is intended to include or refer to substances capable of migrating or issuing into and through the polymeric materials used in the invention and to diffuse, evaporate or otherwise become available on, at or from the surface of said polymeric substances to which said substances have migrated, diffused or issued. Substances encompassed by the term “bio-active material” include, but are not limited to, pesticides, as normally understood, but also such substances as chemosterilants, anti-metabolites, hormones, juvenile hormones, juvenile hormone mimics, analogs and any other substances tending to control or interfere with the normal development of the reproduction process, metamorphosis, mutation and life span of pests and their progeny.

The term “pest attractant”, as used in this specification, is intended to include pheromones and other substances affecting the behavior of pests, such as sex pheromones, trail pheromones, food pheromones, aggregating pheromones and other attractants having properties which affect the behavior of insects, arthropods, arachnids, nematodes, termites, mammals, such as rodents, and other pests. In some instances pest foods and food analogs act as attractants and are included in this definition.

The term “attractant”, as here employed, refers to a chemical capable of inducing a stimulus in an insect or other pest which causes such insect or pest to perform directive locomotory responses toward the source of stimulation. Attractants may serve to lure insects away from the objects they damage, to lure them toward traps or toxicants, to sample local insect populations, to act as counter-agents in testing repellents or to offset the repellent properties of certain insecticides.

“Migration” or “migrating”: indicates a mass transfer or diffusion, in molecular form, of material through a polymeric layer or material. It excludes bulk transfer through pores or micropores. It is to be understood that as an alternative to any method described herein involving the migration or migrating of a bio-active material through a polymeric layer, bio-active materials according to this invention may instead bulk-transfer through a pore or micropore where the polymeric layer to be traversed is a porous layer.

“Chemosterilants”: substances capable of causing sexual sterility in pests or otherwise interfering with their normal process of reproduction.

“Anti-metabolites”: those pesticides and chemosterilants which cause pests to fail to produce ova or sperm.

“Alkylating agents”: those chemosterilants which function to replace hydrogen in fundamental genetic material with an alkyl group resulting in an effect similar to irradiation effects (i.e., sterility).

“Juvenile Hormones” or “Juvenile Hormone Analogs or Mimics”: substances which stop pest eggs from hatching, disrupt the growth of or deform pest larvae, sterilize adult pests, cause mutation or otherwise interfere with, affect or control the normal process of reproduction or metamorphosis of pests.

“Mass-distributing” or “Mass distribution”: positioning or making accessible by any means, including spraying or aerial application, and resulting in the monolayer or multilayer structures of the invention being present in the predetermined application area in a total amount of from 1 to 10,000 g/acre, more preferably from 10 to 500 g/acre, based on the weight of the structures, or the bio-active material being present in the predetermined application area in a total amount of from 0.1 to 5,000 g/acre, more preferably from 0.1 to 100 g/acre, based on the weight of the bioactive material.

The term “monolayer of multilayer structures” is intended to include coated and/or surface-treated single and multilayer structures. Surface-treatment, when desired, may be effected by any of various techniques, including, for example, flame treatment, corona treatment, plasma treatment, and metallization. The structures may be coated with any coating, including, by way of example, a primer coating, e.g., a polyvinylidene chloride (PVdC), acrylic, or silicon oxide (SiOₓ) coating, a water-based coating, or a coating comprising inorganic particles, such as clay, calcium carbonate, or titanium oxide, dispersed in a binder, such as an iminated butyl acrylate copolymer.

Furthermore, in embodiments wherein the layer or layers of the monolayer or multilayer structures comprise a film-forming thermoplastic polymer, it is possible for one or more of the layers to contain dispersed within the respective matrix appropriate additives in effective amounts, including anti-blocks, anti-static agents, anti-oxidants, anti-condensing agents, co-efficient of friction (COF) modifiers (slip agents), processing aids, colorants, clarifiers, foaming agents, flame retardants, photodegradable agents, UV sensitizers or UV blocking agents, crosslinking agents, ionomers and any other additives known to those skilled in the art.

What is claimed is:

1. A method of pest control, comprising mass-distributing throughout a predetermined application area monolayer or multilayer structures comprising a bio-active material in at least one layer thereof.

2. The method of claim 1, wherein the monolayer or multilayer structures are mass-distributed by ground or aerial application.

3. The method of claim 2, wherein the monolayer or multilayer structures are mass-distributed by spraying or blowing.

4. The method of claim 3, wherein the monolayer or multilayer structures are mass-distributed by spraying with the aid of a fluid carrier selected from the group consisting of air, water, fertilized solutions, and herbicide solutions.

5. The method of claim 1, wherein the predetermined application area is an orchard.

6. The method of claim 1, wherein the structures comprise a three-layer film structure comprising, in order, a first outer layer, a middle reservoir layer, and a second outer layer.

7. The method of claim 6, wherein the middle reservoir layer comprises the bio-active material.

8. The method of claim 1, wherein the bio-active material comprises a pest attractant.

9. The method of claim 8, wherein the pest attractant is a pheromone.

10. The method of claim 9, wherein the pheromone comprises (E,E)-8,10-dodecadien-1-ol.

11. The method of claim 10, wherein the predetermined application area is an apple orchard.

12. The method of claim 9, wherein at least some of the monolayer or multilayer structures further comprise, in addition to the pheromone, a second bio-active material.

13. The method of claim 12, wherein the second bio-active material is selected from the group consisting of a pesticide, a chemosterilant, an anti-metabolite, a juvenile hormone, and a pheromone.

14. The method of claim 9, wherein, after mass-distribution, the monolayer or multilayer structures provide at least two phases of pest control in the predetermined application area: a first phase comprising generation of a masking cloud of pheromone; and a second phase comprising generation of false trails of pheromone.

15. The method of claim 1, wherein the monolayer or multilayer structures comprise a first group of monolayer or multilayer structures comprising a first bio-active material in at least one layer thereof and a second group of monolayer or multilayer structures comprising a second bio-active material in at least one layer thereof, wherein the first and second bio-active materials are different.

16. The method of claim 1, wherein, after mass-distribution, the monolayer or multilayer structures are present in the predetermined application area in a total amount of from 1 to 10,000 g/acre, based on the weight of the monolayer or multilayer structures.

17. The method of claim 1, wherein, after mass-distribution, the bio-active material is present in the predetermined application area in a total amount of from 0.1 to 5,000 g/acre, based on the weight of the bioactive material.

18. The method of claim 1, wherein the monolayer or multilayer structures are mass-distributed by mechanical spreading.

19. The method of claim 18, wherein the monolayer or multilayer structures are mass-distributed by mechanical spreading with an adhesive.

20. The method of claim 18, wherein the monolayer or multilayer structures are mass-distributed by mechanical spreading without an adhesive.
